(19) United States
(12) Patent Application Publication
(10) Pub. No.: US 2026/0138122 A1
(43) Pub. Date: May 21, 2026

(54) CATALYST FOR DRY AUTOTHERMAL REFORMING OF PROCESS FLUE GAS AND METHOD OF MANUFACTURING SAME

(71) Applicant: INSTITUTE FOR ADVANCED ENGINEERING, Yongin-si (KR)

(72) Inventors: Jin Hee LEE, Yongin-si (KR); Tae Jin KANG, Yongin-si (KR); Suk Hwan KANG, Yongin-si (KR); Hyo Sik KIM, Yongin-si (KR); Jin Ho KIM, Yongin-si (KR); Ji Hyeon KIM, Yongin-si (KR); Hyun Ji KIM, Yongin-si (KR); Da Hye LEE, Yongin-si (KR); Jae Hong RYU, Yongin-si (KR)

(73) Assignee: INSTITUTE FOR ADVANCED ENGINEERING, Yongin-si (KR)

(21) Appl. No.: 19/059,141

(22) Filed: Feb. 20, 2025

(30) Foreign Application Priority Data
Nov. 19, 2024 (KR) 10-2024-0164852

(51) Int. Cl. B01J 23/83; B01J 35/61; B01J 35/63; B01J 35/64; B01J 35/80; B01J 37/02; B01J 37/04; B01J 37/08; C01B 3/40

(52) U.S. Cl. CPC B01J 23/83; B01J 35/615; B01J 35/633; B01J 35/647; B01J 35/80; B01J 37/0205; B01J 37/0213; B01J 37/04; B01J 37/08; C01B 3/40; C01B 2203/0244; C01B 2203/1058; C01B 2203/1241; C01B 2203/80

(57) ABSTRACT

Disclosed are a catalyst for producing synthesis gas through dry autothermal reforming reaction without a carbon dioxide capture process and a method of manufacturing the same, in which industrial process flue gas is directly utilized as reformer feedstock in a process for producing synthesis gas at a pilot demonstration (20 tons per year) scale through non-capture carbon dioxide chemical conversion by converting low-concentration carbon dioxide in industrial process flue gas and for implementing a carbon dioxide conversion process at a scale of 10,000 tons per year.

### CROSS REFERENCE TO RELATED APPLICATION

This non-provisional application claims the benefit under 35 U.S.C. § 119 (a) to Patent Application No. 10-2024-0164852, filed in the Republic of Korea on Nov. 19, 2024, which is hereby expressly incorporated by reference into the present application.

### TECHNICAL FIELD

The present invention relates to a catalyst for dry autothermal reforming of process flue gas and a method of manufacturing the same, and more particularly, to a catalyst for producing synthesis gas through dry autothermal reforming reaction without a carbon dioxide capture process and a method of manufacturing the same, in which industrial process flue gas is directly utilized as reformer feedstock in a process for producing synthesis gas at a pilot demonstration (20 tons per year) scale through non-capture carbon dioxide chemical conversion by converting low-concentration carbon dioxide in industrial process flue gas and for implementing a carbon dioxide conversion process at a scale of 10,000 tons per year.

### BACKGROUND ART

As efforts to reduce greenhouse gases are being strengthened as part of international climate change response and transition from carbon neutrality to a net-zero policy toward decarbonization is underway, carbon capture utilization and storage (CCUS) technology is emerging as a key technique for achieving carbon neutrality by 2050, and is receiving attention as a promising new climate-related industry while expanding technology development, facility investment, and demonstration, centered around major advanced countries.

Carbon capture utilization and storage (CCUS) is technology that literally captures, utilizes, or stores/sequesters carbon, and means “recycling” the captured carbon dioxide.

In October 2020, the Republic of Korea declared carbon neutrality by 2050 as its national vision and established the “2050 Carbon Neutral Scenario” (2021) as a follow-up response, and established two scenarios to reduce domestic net emissions to zero. Plan A, which reduces emissions as much as possible, such as by completely stopping fossil fuel power generation, and Plan B, which actively utilizes removal technology such as CCUS while maintaining thermal power generation, were announced.

The reason why attention is once again focused on CCUS development is as follows. In order to limit the global temperature rise to 1.5° C. by 2050 as promised in the Paris Climate Agreement, increasing the use of renewable energy, improving energy efficiency, and electrifying energy use are essential. To this end, however, a fundamental restructuring of the industrial structure is required, which is not possible immediately, so CCUS technology may be used as an effective method in the process of gradual restructuring.

Countries that have high carbon-emitting industries and are dependent on exports will inevitably have to invest in CCUS technology and take strategic measures, as they will not only bear the burden of the carbon border tax that is being introduced in Europe and the United States, but will also face a large economic burden due to the introduction of a carbon tax domestically.

If CCUS technology can offset some carbon emissions or provide carbon credits that can be traded, it will not only generate secondary income but also serve as an incentive for companies to adopt CCUS technology.

The industries with high carbon emissions are, in order, steel (25%), cement (25%), and chemicals and petrochemical products (30%), and these are all industries that Korea leads in.

It has been reported that in order to utilize carbon dioxide contained in process flue gas, a carbon dioxide capture process (wet or dry) and a compression process are required (excluding carbon mineralization). When applying the carbon dioxide capture process, various materials and facilities are required, including facility costs, operating costs, absorbent (liquid or solid), heat source supply for regeneration (dry: 200-250° C., wet: about 80° C.), compression and storage facilities, etc.

In particular, it is necessary to develop techniques for producing compounds utilizing CO2 and 02 in combustion flue gas and to develop catalysts for producing synthesis gas through dry autothermal reforming reaction without a carbon dioxide capture process by Supplying low-concentration carbon dioxide emitted from flue gas, oxygen, and natural gas or bio-methane and methods of manufacturing the same.

Korean Patent Application Publication No. 2009-0045519 discloses a catalyst and catalyst layer necessary for obtaining a hydrogen-to-carbon monoxide ratio (H2/CO: about 2) suitable for the Fischer-Tropsch Process, and reaction conditions using the same, while converting methane or natural gas into hydrogen and carbon monoxide by partial oxidation reaction and additional reaction, including steam reforming and (reverse) water gas shift reaction ((R)WGS).

Korean Patent Application Publication No. 2016-0061766 discloses a catalyst composition for producing synthesis gas by carbon dioxide reforming reaction of methane, which includes a mixture of a solid acid and iron, and a method of producing synthesis gas by carbon dioxide reforming reaction of methane, including producing synthesis gas by decomposing carbon dioxide and methane using the catalyst composition.

Korean Patent Application Publication No. 2016-0107539 discloses a catalyst for producing synthesis gas by carbon dioxide reforming of methane gas, a method of manufacturing the same, and a method of producing synthesis gas using the same, in which the catalyst includes iron (Fe) particles and a solid acid carrier, which may maximize the reaction stabilization and reaction sustainability of the catalyst by minimizing coke formation and carbon deposition, in a process for producing hydrogen and carbon monoxide by carbon dioxide reforming of methane where carbon accumulates on the catalyst surface and rapidly deteriorates the activity of the catalyst, and may maintain high synthesis gas conversion efficiency of methane and carbon dioxide.

Korean Patent No. 10-0732729 discloses a nickel-based catalyst in which nickel is supported as an active metal on a zirconia carrier, in which the zirconia carrier is doped with a mixed metal including yttrium as an essential metal and a metal selected from among a lanthanide element and an alkaline earth metal element to induce distortion of the zirconia crystal lattice, thereby facilitating movement of oxygen ions and efficiently storing and supplying oxygen, thereby suppressing carbon deposition on the surface of the nickel active metal, ultimately obtaining the effect of maintaining the activity of the catalyst and extending the lifetime of the catalyst. In particular, a nickel-based catalyst, which is used as a catalyst for tri-reforming reaction of methane using a mixed gas of carbon dioxide, oxygen, and steam as an oxidizing agent and which is capable of selectively controlling the hydrogen-to-carbon monoxide ratio (H2/CO) in synthesis gas, and a method of producing synthesis gas by tri-reforming methane in the presence of the nickel-based catalyst are disclosed.

However, the conventional techniques described above have not disclosed technology for a catalyst for non-capture carbon dioxide dry autothermal reforming and a method of manufacturing the same in which industrial process flue gas and semi-carbonated flue gas are directly utilized as reformer feedstock to produce synthesis gas by dry autothermal reforming reaction using flue gas containing low-concentration carbon dioxide and oxygen and bio-methane as feedstock without a separate capture process for increasing the concentration of carbon dioxide in industrial process flue gas according to the present invention.

Accordingly, there is a need to develop a catalyst for producing synthesis gas through dry autothermal reforming reaction without a carbon dioxide capture process and a method of manufacturing the same, in which methane produced in waste processes, industrial process flue gas, and, if necessary, semi-carbonated flue gas, are directly utilized as reformer feedstock in a process for producing synthesis gas at a pilot demonstration scale (20 tons per year) through non-capture carbon dioxide chemical conversion by converting low-concentration carbon dioxide in industrial process flue gas under high heat absorption conditions required for reforming reaction of carbon dioxide and methane, and for implementing a carbon dioxide conversion process at a scale of 10,000 tons per year.

### PRIOR ART DOCUMENTS

### Patent Documents

(Patent Document 0001) Korean Patent Application Publication No. 2009-0045519

(Patent Document 0002) Korean Patent Application Publication No. 2016-0061766

(Patent Document 0003) Korean Patent Application Publication No. 2016-0107539

(Patent Document 0004) Korean Patent No. 10-0732729

### SUMMARY OF INVENTION

### Technical Problem

The present invention has been made keeping in mind the problems encountered in the related art, and an object of the present invention is to provide a catalyst for producing synthesis gas through dry autothermal reforming reaction without a carbon dioxide capture process and a method of manufacturing the same, in which flue gas is directly utilized in a process for producing synthesis gas at a pilot demonstration scale (20 tons per year) through non-capture carbon dioxide chemical conversion by converting low-concentration carbon dioxide in industrial process flue gas, and for implementing a carbon dioxide conversion process at a scale of 10,000 tons per year.

Another object of the present invention is to provide a catalyst for producing synthesis gas through dry autothermal reforming reaction without a carbon dioxide capture process by supplying natural gas or bio-methane to process flue gas containing carbon dioxide (4-25%), as technology corresponding to carbon dioxide utilization among key techniques for carbon neutrality, and a method of manufacturing the same.

Still another object of the present invention is to provide a catalyst for producing synthesis gas through dry autothermal reforming reaction and a method of manufacturing the same, in which it is necessary to develop technology that may be utilized directly without a carbon dioxide capture process if possible because the carbon dioxide capture process has a limited operating range (processing capacity and carbon dioxide concentration) and, if the carbon dioxide concentration changes, the process efficiency and performance may not reach the design value.

### Technical Solution

In order to accomplish the above objects, the present invention provides a metal-inorganic metal oxide catalyst for dry autothermal reforming, including flue gas containing low-concentration carbon dioxide having a carbon dioxide concentration of 10 vol % to 25 vol %, methane, and at least one metal supported on an inorganic metal oxide support for dry autothermal reforming reaction of the flue gas and the methane.

Also, the inorganic metal oxide may be at least one selected from the group consisting of CaO, ZnO, MoO3, NiO, K2O, MgO, SiO2, Al2O3, Na2O, SrO, BaO, P4O6, Fe2O3, TiO2, and ZrO2.

Also, the metal may be at least one selected from the group of metal salts consisting of tin (Sn), nickel (Ni), iridium (Ir), cerium (Ce), magnesium (Mg), yttrium (Y), and cesium (Cs).

Also, a first metal (Mg)-inorganic metal oxide support may be formed by adding a solution including a first metal salt among the metal salts to the inorganic metal oxide (Al2O3) support.

Also, the first metal-inorganic metal oxide support may be impregnated with a second metal (Ce) by further adding an aqueous nickel cerium nitrate solution including a second metal salt among the metal salts.

Also, the first metal salt may be added in an amount of 1 part by weight to 10 parts by weight, and the second metal salt may be added in an amount of 1 part by weight to 10 parts by weight, based on 100 parts by weight of the inorganic metal oxide.

Also, after adding the first metal salt, moisture may be removed using a rotary evaporator, and the first metal-inorganic metal oxide support may be obtained by leaving at 700° C. to 1,000° C. for 6 to 10 hours in an air atmosphere in a furnace.

Also, after adding the second metal salt, moisture may be removed using a rotary evaporator, and the first metal-inorganic metal oxide support may be impregnated with the second metal of the second metal salt by leaving at 700° C. to 1,000° C. for 6 to 10 hours in an air atmosphere in a furnace.

amorphous inorganic metal oxide (NiO) may be further added in an amount of 5 parts by weight to 40 parts by weight to the solution including the second metal salt.

In addition, the present invention provides a method of manufacturing a metal-inorganic metal oxide catalyst for dry autothermal reforming including flue gas containing low-concentration carbon dioxide having a carbon dioxide concentration of 10 vol % to 25 vol %, methane, and at least one metal supported on an inorganic metal oxide support for dry autothermal reforming reaction of the flue gas and the methane, including a first step of preparing a pellet-shaped porous inorganic metal oxide support, a second step of adding a first metal to the inorganic metal oxide support and removing moisture, a third step of forming a first metal-inorganic metal oxide support by calcining a material obtained in the second step in an air atmosphere, a third step of adding a second metal and an amorphous inorganic metal oxide to the first metal-inorganic metal oxide support and removing moisture, and a fourth step of impregnating the first metal-inorganic metal oxide support with the second metal and the metal of the amorphous inorganic metal oxide by calcining a material obtained in the third step in an air atmosphere.

Also, the inorganic metal oxide may be at least one selected from the group consisting of CaO, ZnO, MoO3, NiO, K2O, MgO, SiO2, Al2O3, Na2O, SrO, BaO, P4O6, Fe2O3, TiO2, and ZrO2.

Also, the metal may be at least one selected from the group of metal salts consisting of tin (Sn), nickel (Ni), iridium (Ir), cerium (Ce), magnesium (Mg), yttrium (Y), and cesium (Cs).

Also, the first metal salt including the first metal may be added in an amount of 1 part by weight to 10 parts by weight, and the second metal salt including the second metal may be added in an amount of 1 part by weight to 10 parts by weight, based on 100 parts by weight of the inorganic metal oxide.

Also, the amorphous inorganic metal oxide (NiO) may be further added in an amount of 5 parts by weight to 40 parts by weight to the solution including the second metal salt.

The present invention may also be provided in the form of various combinations of the technical solution described above.

### Advantageous Effects of the Invention

As is apparent from the foregoing, according to the present invention, a catalyst for producing synthesis gas through dry autothermal reforming reaction without a carbon dioxide capture process and a method of manufacturing the same are capable of achieving energy conservation and greenhouse gas reduction effects because there is no carbon dioxide capture process, and improving process efficiency and operation by linking with a chemical feedstock synthesis process.

In addition, by virtue of dry autothermal reforming reaction in which carbon dioxide emitted from gas reacts with bio-methane and oxygen contained in flue gas, the reaction temperature maintenance is high compared to endothermic reaction of dry reforming, and coke formation can be effectively suppressed.

In addition, since heat is supplied in an indirect heating manner, the temperature decreases toward the center of a reactor (reformer), and since heat tends to rise upward, the upper portion of the reactor has high heat, and the lower portion thereof has low heat. Therefore, in order to suppress coke formation, a low-activity catalyst is placed in the low-temperature section, and in order to increase conversion efficiency by maintaining a constant temperature gradient inside the reactor, a low/medium-activity catalyst is placed in the high-temperature section and a high-activity catalyst is placed in the low-temperature section.

In addition, since reforming reaction is used after sulfide removal downstream of discharge of flue gas, it is possible to control poisoning by sulfide.

In addition, synthesis gas (CO2+CH4→2H2) that is produced using carbon dioxide contained in flue gas can be converted into dimethyl ether (DME)/methyl acetate (MA)/ethanol (EtOH)/acetic acid (AA) through multi-step reactions, along with the greenhouse gas reduction effect, whereby useful platform chemicals can be developed.

In addition, the hydroxyl groups of biomass can be reduced through a process of semi-carbonating biomass in a short period of time, preferably within 7 minutes, using a low-pressure semi-carbonation heat source, thus imparting hydrophobic properties and maintaining low moisture content. Thereby, problems caused by moisture absorption during storage or transport of biomass can be solved, calorific value can be increased, and grindability can be improved.

### BRIEF DESCRIPTION OF DRAWINGS

FIG. 1 is a table comparing a conventional carbon dioxide utilization process and a process using a dry autothermal reforming catalyst according to the present

### Invention;

FIG. 2 is a table comparing the specific surface area, total pore volume, and average pore size of a dry autothermal reforming catalyst according to an embodiment of the present invention and a commercial catalyst;

FIG. 3 is a graph showing CO2 conversion efficiency and CH4 conversion efficiency depending on the reaction time when the dry autothermal reforming catalyst according to an embodiment of the present invention is applied to a three-channel reactor;

FIG. 4 is a graph showing CO₂ conversion efficiency and CH₄ conversion efficiency depending on the reaction time of the dry autothermal reforming catalyst according to an embodiment of the present invention and a commercial catalyst;

FIG. 5 is a graph showing H₂-TPR results of the dry autothermal reforming catalyst according to an embodiment of the present invention;

FIG. 6 is a graph showing H₂-TPR results of a commercial catalyst of Comparative Example;

FIG. 7 is a photograph showing the catalyst state after 1 hour of reaction of the commercial catalyst of Comparative Example; and

FIG. 8 is XRD graphs for analyzing the physical and chemical bonding state and phase of the metals included in the dry autothermal reforming catalyst according to an embodiment of the present invention.

### DESCRIPTION OF EMBODIMENTS

Hereinafter, embodiments of the present invention will be described in detail with reference to the appended drawings so as to easily perform the present invention by those having ordinary skill in the art to which the present invention pertains. However, in explaining the operating principle of preferred embodiments of the present invention in detail, if it is determined that a specific description of the related known functions or configurations may unnecessarily obscure the gist of the present invention, the detailed description thereof is omitted.

Also, limitations or additions to any embodiment herein may be applied not only to a particular embodiment, but may also be applied equally to other embodiments.

Also, throughout the description and claims of the present invention, the singular includes the plural unless stated otherwise.

A detailed description will be given of the present invention with reference to the drawings.

Anyone with ordinary skill in the art will be able to perform various applications and modifications within the scope of the present invention based on the disclosure of the present invention.

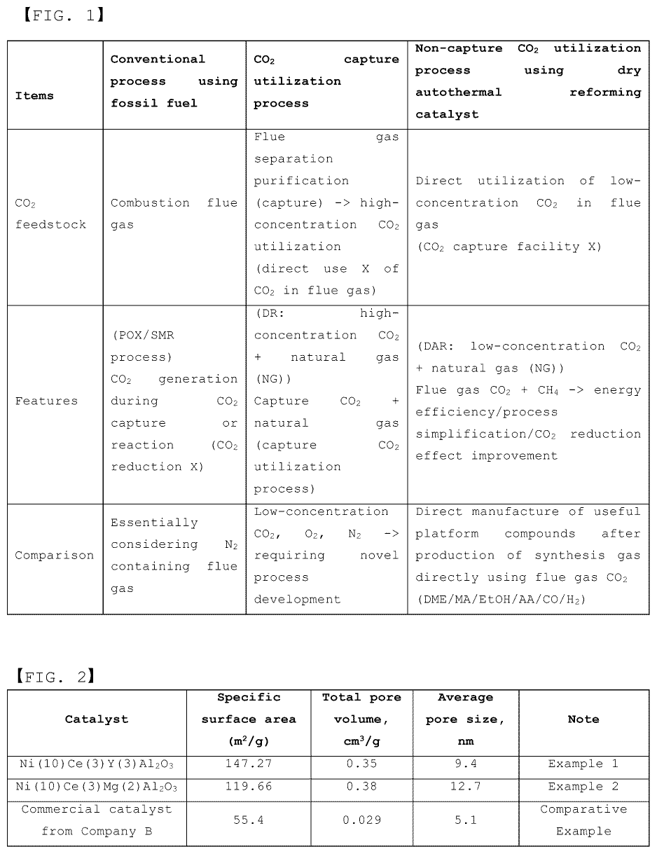

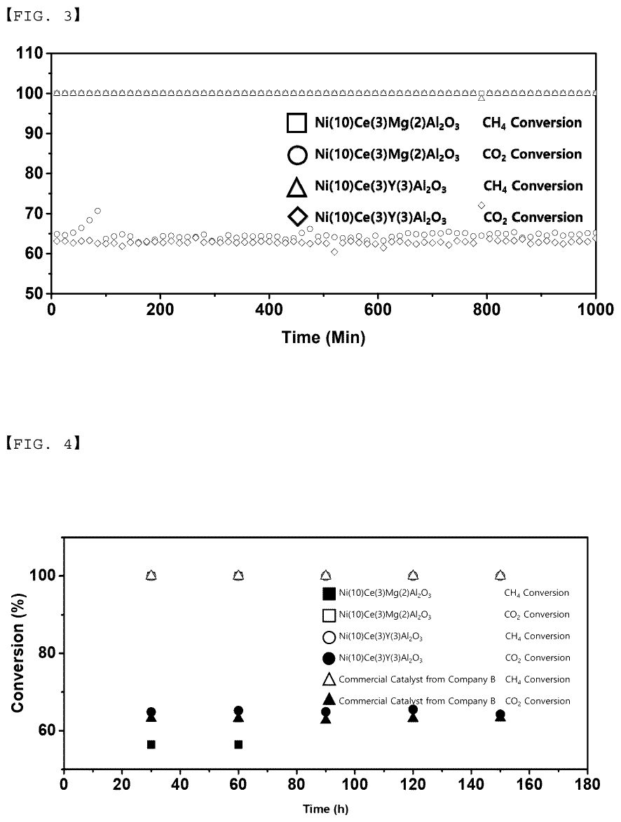

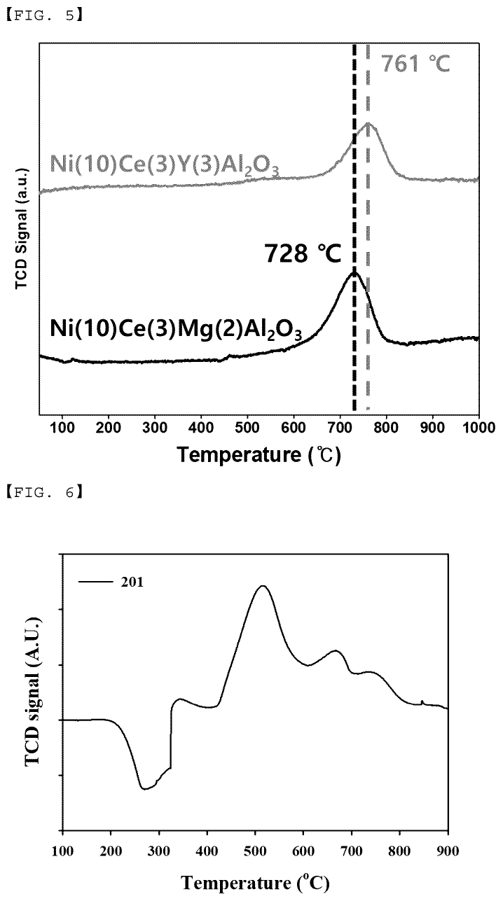

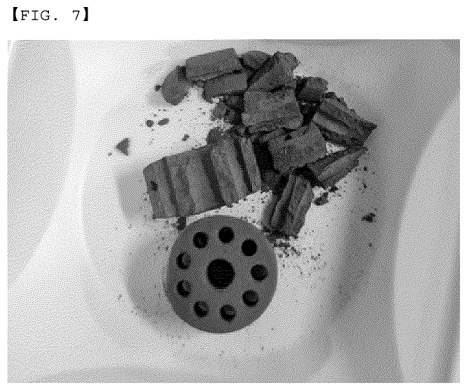

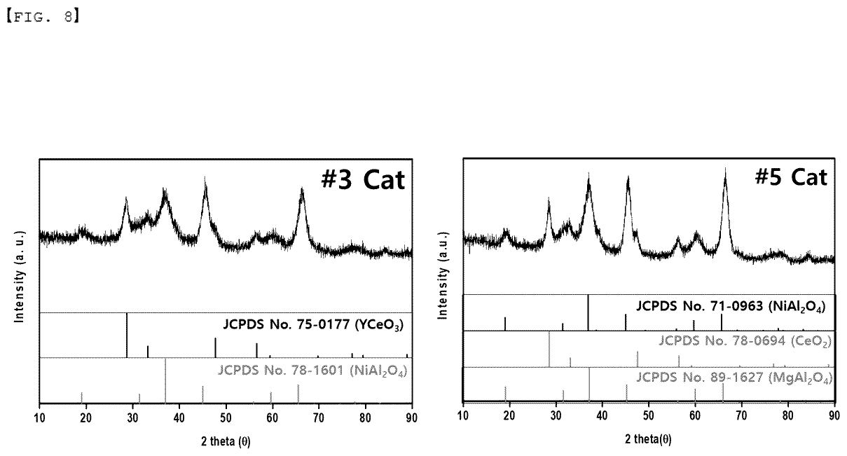

FIG. 1 is a table comparing a conventional carbon dioxide utilization process and a process using a dry autothermal reforming catalyst according to the present invention.

In a conventional process using fossil fuel, carbon dioxide feedstock is combustion flue gas, and carbon dioxide may be generated during carbon dioxide capture or reaction using a partial oxidation process and/or a steam methane reforming process, so there is no benefit in reducing carbon dioxide. Also, the effect of nitrogen contained in the flue gas on the reaction has also to be considered.

For the carbon dioxide capture utilization process, there is a capture process that separates and purifies carbon dioxide from flue gas, and thus high-concentration carbon dioxide is utilized. Hence, it is impossible to construct a process that directly utilizes low-concentration carbon dioxide in flue gas.

This is a process that utilizes captured carbon dioxide to produce synthesis gas by reaction between captured carbon dioxide and natural gas through dry reforming including reaction between high-concentration carbon dioxide and natural gas. Therefore, a new process is required for dry reforming of carbon dioxide in flue gas that has not been subjected to a capture process containing low-concentration carbon dioxide, oxygen, and nitrogen.

A non-capture carbon dioxide utilization process using the dry autothermal reforming catalyst of the present invention is a process that directly utilizes low-concentration carbon dioxide in flue gas, thus obviating the need for a carbon dioxide capture facility that consumes a large amount of energy.

Synthesis gas may be produced from low-concentration carbon dioxide and natural gas containing methane using dry autothermal reforming. Therefore, the energy efficiency, process simplification, and carbon dioxide reduction effects are relatively high.

Low-concentration carbon dioxide in flue gas may be directly used to produce synthesis gas, from which useful platform compounds may then be directly manufactured. As such, the materials that may be produced may be DME (dimethyl ether), MA (methyl acetate), EtOH (ethanol), and AA (acetic acid).

A metal-inorganic metal oxide catalyst for dry autothermal reforming includes flue gas containing low-Concentration carbon dioxide having a carbon dioxide concentration of 10 vol % to 25 vol %, methane, and at least one metal supported on an inorganic metal oxide support for dry autothermal reforming reaction of the flue gas and the methane.

Also, the inorganic metal oxide may be at least one selected from the group consisting of CaO, ZnO, MoO3, NiO, K2O, MgO, SiO2, A12O3, Na2O, SrO, BaO, P4O6, Fe2O3, TiO2, and ZrO2.

When the metal, preferably a cocatalyst, is supported on the surface of the inorganic metal oxide support, excellent catalytic activity may be exhibited due to an increase in active sites, and the effect of reducing the influence of a decrease in catalytic activity due to adsorption of carbon monoxide may be exerted compared to when the metal cocatalyst is independently dispersed.

The metal cocatalyst may include at least one metal selected from the group consisting of tin (Sn), nickel (Ni), iridium (Ir), cerium (Ce), magnesium (Mg), yttrium (Y), and cesium (Cs), and specifically may include at least one metal selected from the group consisting of iridium (Ir), cerium (Ce), yttrium (Y), and cesium (Cs). When the metal cocatalyst is supported on the surface of the inorganic metal oxide support, the metal cocatalyst may act as a catalyst for carbon dioxide, and specifically, may serve to produce carbon monoxide and/or hydrocarbons.

The metal-supported inorganic metal oxide catalyst additionally includes carbon nanotubes, and in the mixture of the metal-inorganic metal oxide catalyst and the carbon nanotubes, the carbon nanotubes and the metal cocatalyst electrically interact so that the carbon nanotubes attract electrons from the metal cocatalyst. Accordingly, the carbon nanotubes may be partially negatively charged, and the metal cocatalyst may be partially positively charged. Specifically, the carbon nanotubes included in the composite catalyst for electrochemical carbon dioxide reduction reaction have electronegative characteristics, which cause the metal cocatalyst supported on the inorganic metal oxide support to be electrically positively charged, thereby inducing reaction intermediates such as CO2- or COOH-generated in the electrochemical carbon dioxide reduction reaction to be adsorbed on the catalyst and stabilized, thereby enhancing the catalytic activity.

In addition, a solution including a first metal salt among the metal salts may be added to the inorganic metal oxide (Al2O3) support, forming a first metal (Mg)-inorganic metal oxide support.

The solution may be an aqueous magnesium nitrate solution.

In addition, a solution including a second metal salt among the metal salts may be further added to the first metal-inorganic metal oxide support, so that the first metal-inorganic metal oxide support may be impregnated with the second metal (Ce).

The solution may be an aqueous nickel cerium nitrate solution.

Also, based on 100 parts by weight of the inorganic metal oxide, the first metal salt may be added in an amount of 1 part by weight to 10 parts by weight, and the second metal salt may be added in an amount of 1 part by weight to 10 parts by weight. Preferably, the first metal salt is added in an amount of 3 parts by weight to 8 parts by weight, and the second metal salt is added in an amount of 3 parts by weight to 8 parts by weight, based on 100 parts by weight of the inorganic metal oxide. Outside the above ranges, it is difficult to effectively form a first metal-inorganic metal oxide support.

### First Embodiment

A novel dry autothermal reforming catalyst, in which the surface of a support in which Al2O3 is mixed with additives such as Ce, Mg, Y, etc. in predetermined proportions (1-10 wt %) is formed with specific metals including amorphous Ni oxide (5-40 wt %) and a Cs additive (1-10 wt %), is manufactured.

An Mg salt is added to Al2O3 pellets and moisture is removed through a sequential impregnation process using a rotary evaporator.

The dried sample is heated to 850° C. for 2 hours in a box furnace and then maintained for 8 hours, synthesizing an Mg Al2O4 support.

Next, a Ni-Ce solution is added to the synthesized Mg Al2O4 pellets and moisture is removed using a rotary evaporator.

The dried sample is heated to 850° C. for 2 hours using a box furnace and then calcined for 8 hours in an air atmosphere, obtaining Ni-Ce/Mg Al2O4.

In addition, after adding the first metal salt, moisture may be removed using a rotary evaporator, and a first metal-inorganic metal oxide support may be obtained by leaving at 700° C. to 1,000° C. for 6 to 10 hours in an air atmosphere in a furnace. If the conditions fall outside the above ranges, the first metal-inorganic metal oxide support cannot be effectively formed.

In addition, after adding the second metal salt, moisture may be removed using a rotary evaporator, and the first metal-inorganic metal oxide support may be impregnated with the second metal of the second metal salt by leaving at 700° C. to 1,000° C. for 6 to 10 hours in an air atmosphere in a furnace. If the conditions fall outside the above ranges, the first metal-inorganic metal oxide support cannot be effectively impregnated with the second metal.

Also, an amorphous inorganic metal oxide may be further added in an amount of 5 parts by weight to 40 parts by weight to the solution including the second metal salt. If the conditions fall outside the above range, the first metal-inorganic metal oxide support cannot be effectively impregnated with the second metal and the metal of the amorphous inorganic metal oxide.

The inorganic metal oxide may be NiO.

In the conventional dry reforming reaction of CO2 and CH4, the lower the CH4/CO2 ratio in reactants, the higher the resistance to coke formation. However, in the process containing oxygen, the higher the CH4/CO2 ratio, the higher the CO2 conversion efficiency and H2/CO ratio, and the catalyst deactivation due to coke formation is resolved by use of oxygen. Using these catalysts, it is possible to directly convert process flue gas into synthesis gas, and then to produce various platform compounds (acetic acid, methyl acetate, EtOH, DME, etc.) using the synthesis gas.

To this end, the present invention provides a method of manufacturing a metal-inorganic metal oxide catalyst for dry autothermal reforming including flue gas containing low-concentration carbon dioxide having a carbon dioxide concentration of 10 vol % to 25 vol %, methane, and at least one metal supported on an inorganic metal oxide support for dry autothermal reforming reaction of the flue gas and the methane, the method including a first step of preparing a pellet-shaped porous inorganic metal oxide support, a second step of adding a first metal to the inorganic metal oxide support and removing moisture, a third step 4 forming a first metal-inorganic metal oxide support by calcining the material obtained in the second step in an air atmosphere, a third step of adding a second metal and an amorphous inorganic metal oxide to the first metal-inorganic metal oxide support and removing moisture, and a fourth step of impregnating the first metal-inorganic metal oxide support with the second metal and the metal of the amorphous inorganic metal oxide by calcining the material obtained in the third step in an air atmosphere.

The manufacture of the catalyst includes a step of doping a pellet-shaped porous support with a metal salt to improve performance of the support and a step of dissolving two or more metal salts in a solvent and performing impregnation therewith using a rotary evaporator. The mixture of impregnated metal salt and porous support is calcined at 850° C. in an air atmosphere.

In addition, the inorganic metal oxide may be at least one selected from the group consisting of CaO, ZnO, MoO3, NiO, K2O, MgO, SiO2, Al2O3, Na2O, SrO, BaO, P4O6, Fe2O3, TiO2, and ZrO2.

Also, the metal may be at least one selected from the group of metal salts consisting of tin (Sn), nickel (Ni), iridium (Ir), cerium (Ce), magnesium (Mg), yttrium (Y), and cesium (Cs).

In addition, based on 100 parts by weight of the inorganic metal oxide, the first metal salt including the first metal may be added in an amount of 1 part by weight to 10 parts by weight, and the second metal salt including the second metal may be added in an amount of 1 part by weight to 10 parts by weight.

Also, the amorphous inorganic metal oxide (NiO) may be further added in an amount of 5 parts by weight to 40 parts by weight to the solution including the second metal salt.

In dry reforming reaction using carbon dioxide and methane, the temperature of the catalyst layer locally rapidly drops due to strong endothermic reaction, which generates coke through the Boudouard reaction, blocking the active sites of the catalyst and causing deactivation. In addition, reactants containing oxygen cause oxidation of the catalyst, which rapidly deteriorates the catalytic activity due to deactivation of the catalyst.

When 1 to 10 wt % of Ce (cerium) is added during catalyst preparation, Ce facilitates movement of oxygen ions so that oxygen of the reactant does not oxidize nickel as the active material, and serves to selectively remove the formed coke. After reaction, it is confirmed through catalyst analysis that no nickel oxide component is detected.

FIG. 2 is a table comparing the specific surface area, total pore volume, and average pore size of the dry autothermal reforming catalyst according to an embodiment of the present invention and a commercial catalyst.

Example 1 is an Al2O3 dry autothermal reforming catalyst including 10 wt % of Ni, 3 wt % of Ce, and 3 wt % of Y, and Example 2 is an Al2O3 dry autothermal reforming catalyst including 10 wt % of Ni, 3 wt % of Ce, and 2 wt % of Mg. Comparative Example is a commercial catalyst from Company B.

For the specific surface area, the specific surface area values of Examples 1 and 2 were at least two times the value of the commercial catalyst.

The total pore volumes capable of supporting metal were 0.35 cm 3/g in Example 1 and 0.38 cm3 /g in Example 2, which were about 10 times higher than 0.029 cm3 /g, the volume value of the commercial catalyst from Company B.

For the average pore size, Example 1 had an average pore size of 9.4 nm and Example 2 had an average pore size of 12.7 nm, which were at least about two times 5.1 nm, the average pore size of Comparative Example.

FIG. 3 is a graph showing CO2 conversion efficiency and CH4 conversion efficiency depending on the reaction time when the dry autothermal reforming catalyst according to an embodiment of the present invention is applied to a three-channel reactor.

The reaction experiment was performed using a three-channel reactor, and the catalysts were loaded in amounts of 5.23 g and 4.84 g, with the same volume of 6.17 ml. In a nitrogen atmosphere, the temperature was raised to 900° C. for 4 hours and 30 minutes, followed by reduction for 2 hours using H2 4%/Ar bal. gas. The reaction was carried out under conditions of GHSV of 4000 h-1 under atmospheric pressure, the total amount of the reaction gas that was supplied equally was 411.22 ml/min, and the CH4/CO2 ratio was 1.1. 40.75 ml/min of methane was fed to 370.46 ml/min of process flue gas containing 10% CO2, 5% O2, and 85% N2. Based on results of measurement of dry autothermal reforming reaction conversion efficiency of the developed catalyst for 1,000 hours, it was confirmed that the CO2 conversion efficiency and CH4 conversion efficiency were steadily maintained without deactivation.

FIG. 4 is a graph showing the CO2 conversion efficiency and CH4 conversion efficiency depending on the reaction time of the dry autothermal reforming catalyst according to an embodiment of the present invention and a commercial catalyst.

Based on results of a comparative experiment for 3 hours between the developed catalyst and the commercial catalyst under conditions of GHSV of 4000 h-1 in a CH4/CO2 ratio of 1.1, the commercial catalyst did not maintain the catalyst shape due to coke after start of reaction and the reactor pressure increased. In addition, the CO2 conversion efficiency of the commercial catalyst was 56.5%, and the CO2 conversion efficiency of the developed catalyst was 60.5%, confirming that the CO2 conversion efficiency the developed catalyst was 4% higher than that of the commercial catalyst.

FIG. 5 is a graph showing H2-TPR results of the dry autothermal reforming catalyst according to an embodiment of the present invention.

Based on the H2-TPR results of the developed catalyst of Example, reduction was confirmed to occur at a lower temperature when Y was used than when Mg was used. H2-TPR was analyzed under the condition that 50 mg of the catalyst was loaded and moisture and an air atmosphere were removed with Ar gas at 150° C. for 1 hour, followed by cooling again to room temperature and then temperature elevation from 30° C. to 1,000° C. at a rate of 5° C./min at a flow rate of 40 ml/min of 5% H2/Ar gas.

FIG. 7 is a photograph showing the catalyst state after hour of reaction of the commercial catalyst of Comparative Example.

The results showed the catalyst state after 1 hour of reaction using the commercial catalyst, which caused an increase in internal pressure of the reactor during reaction.

FIG. 8 is XRD graphs for analyzing the physical and chemical bonding state and phase of the metals included in the dry autothermal reforming catalyst according to an embodiment of the present invention.

#3 catalyst has a composition of Ni(10)Ce(3)Y(3)Al2O3, in which Y and Ce are chemically bonded and provided in the form of a YCeO3 phase and Ni and Al2O3 are chemically bonded and provided in the form of a NiAl2O4 phase. YCeO3 and NiAl2O4 are physically bonded to form a catalyst. #5 catalyst is a Ni(10)Ce(3)Mg(2)Al2O3 catalyst, in which Ni and Al2O3 are chemically bonded to form NiAl2O4, and Mg and A12O3 are chemically bonded to form MgAl2O4. CeO2 is physically bonded with NiAl2O4 and MgA12O4.

Although representative embodiments of the present invention have been described in detail above, those skilled in the art will appreciate that various modifications can be made to the aforementioned embodiments without departing from the scope of the present invention.

Therefore, the scope of the present invention should not be limited to the described embodiments, but should be defined by the following claims and equivalents thereto.

1. A metal-inorganic metal oxide catalyst for dry autothermal reforming, comprising:
flue gas containing low-concentration carbon dioxide having a carbon dioxide concentration of 10 vol % to 25 vol %;
methane; and
at least one metal supported on an inorganic metal oxide support for dry autothermal reforming reaction of the flue gas and the methane.

2. The metal-inorganic metal oxide catalyst according to claim 1, wherein the inorganic metal oxide is at least one selected from the group consisting of CaO, ZnO, MoO3,NiO, K2O, MgO, SiO2, Al2O3, Na2O, SrO, BaO, P4O6, Fe2O3, TiO2, and ZrO2.

3. The metal-inorganic metal oxide catalyst according to claim 2, wherein the metal is at least one selected from the group of metal salts consisting of tin (Sn), nickel (Ni), iridium (Ir), cerium (Ce), magnesium (Mg), yttrium (Y), and cesium (Cs).

4. The metal-inorganic metal oxide catalyst according to claim 3, wherein a first metal-inorganic metal oxide support is formed by adding a solution comprising a first metal salt among the metal salts to the inorganic metal oxide support.

5. The metal-inorganic metal oxide catalyst according to claim 4, wherein the first metal-inorganic metal oxide support is impregnated with a second metal by further adding a solution comprising a second metal salt among the metal salts.

6. The metal-inorganic metal oxide catalyst according to claim 5, wherein the first metal salt is added in an amount of 1 part by weight to 10 parts by weight, and the second metal salt is added in an amount of 1 part by weight to 10 parts by weight, based on 100 parts by weight of the inorganic metal oxide.

7. The metal-inorganic metal oxide catalyst according to claim 4, wherein, after adding the first metal salt, moisture is removed using a rotary evaporator, and the first metal-inorganic metal oxide support is obtained by leaving at 700° C. to 1,000° C. for 6 to 10 hours in an air atmosphere in a furnace.

8. The metal-inorganic metal oxide catalyst according to claim 5, wherein, after adding the second metal salt, moisture is removed using a rotary evaporator, and the first metal-inorganic metal oxide support is impregnated with the second metal of the second metal salt by leaving at 700° C. to 1,000° C. for 6 to 10 hours in an air atmosphere in a furnace.

9. The metal-inorganic metal oxide catalyst according to claim 6, wherein an amorphous inorganic metal oxide is further added in an amount of 5 parts by weight to 40 parts by weight to the solution comprising the second metal salt.

10. A method of manufacturing a metal-inorganic metal oxide catalyst for dry autothermal reforming comprising flue gas containing low-concentration carbon dioxide having a carbon dioxide concentration of 10 vol % to 25 vol %, methane, and at least one metal supported on an inorganic metal oxide support for dry autothermal reforming reaction of the flue gas and the methane, comprising:
a first step of preparing a pellet-shaped porous inorganic metal oxide support;
a second step of adding a first metal to the inorganic metal oxide support and removing moisture;
a third step of forming a first metal-inorganic metal oxide support by calcining a material obtained in the second step in an air atmosphere;
a fourth step of adding a second metal and an amorphous inorganic metal oxide to the first metal-inorganic metal oxide support and removing moisture; and
a fifth step of impregnating the first metal-inorganic metal oxide support with the second metal and a metal of the amorphous inorganic metal oxide by calcining a material obtained in the third step in an air atmosphere.

11. The method according to claim 10, wherein the inorganic metal oxide is at least one selected from the group consisting of CaO, ZnO, MoO₃, NiO, K₂O, MgO, SiO₂, Al₂O₃, Na₂O, SrO, BaO, P₄O₆, Fe₂O₃, TiO₂, and ZrO₂.

12. The method according to claim 11, wherein the metal is at least one selected from the group of metal salts consisting of tin (Sn), nickel (Ni), iridium (Ir), cerium (Ce), magnesium (Mg), yttrium (Y), and cesium (Cs).

13. The method according to claim 10, wherein the first metal salt comprising the first metal is added in an amount of 1 part by weight to 10 parts by weight, and the second metal salt comprising the second metal is added in an amount of 1 part by weight to 10 parts by weight, based on 100 parts by weight of the inorganic metal oxide.

14. The method according to claim 13, wherein the amorphous inorganic metal oxide is further added in an amount of 5 parts by weight to 40 parts by weight to the solution comprising the second metal salt.
